(19) United States
(12) Patent Application Publication
(10) Pub. No.: US 2022/0025584 A1
(43) Pub. Date: Jan. 27, 2022

(54) A paperboard structure, a package and use of the package

(71) Applicant: Metsä Board Oyj, Metsä (FI)

(72) Inventor: Lauri Verkasalo, Metsä (FI)

(21) Appl. No.: 17/312,035

(22) PCT Filed: Dec. 11, 2019
(86) PCT No.: PCT/FI2019/050881

§ 371 Date: Jun. 9, 2021

(30) Foreign Application Priority Data
Dec. 11, 2018 (FI) 20186067

(51) Int. Cl. D21J 1/08; D21J 1/16; B32B 27/10; B32B 27/08; B32B 27/32; B32B 27/20; B32B 1/02; B65D 65/40; B65D 85/00

(52) U.S. Cl. CPC D21J 1/08; B32B 2250/03; B32B 27/10; B32B 27/08; B32B 27/32; B32B 27/20; B32B 1/02; B65D 65/40; B65D 85/70; B32B 2307/732; B32B 2307/718; B32B 2439/62; B32B 2553/00; B32B 2264/104; D21J 1/16

(57) ABSTRACT

According to an example aspect of the present invention, there is provided a paperboard structure, comprising: a support layer comprising paperboard; a filler layer on top of and in direct contact with the support layer, the filler layer comprising an inorganic filler and a polyolefin; and a plastic coating layer on top of the filler layer and forming the outermost layer of the paperboard structure, the plastic coating layer comprising a polyolefin.

### FIELD

The present invention relates to coated paperboards, and more particularly to barrier coatings containing fillers.

### BACKGROUND

### Background

Barriers are used in paper and paperboard products to prevent unwanted substances to penetrate through the material. Such unwanted substances can be for example: water, water vapour, oxygen, fat, flavourings and components of mineral oil. Plastic materials are typically used as the material of the barrier layer, blended with various additives and fillers.

In paperboards, barriers that are extruded or applied as dispersions are generally used. The barrier is applied either onto the back side or the surface of the paperboard. Barrier application is usually carried out as an off-line operation, where the paperboard manufactured at the paperboard mill is lengthwise cut into suitable rolls, packed, transported to the processing plant, coated with a barrier at the processing plant, packed and sent to the customer.

In the food packaging industry, it is imperative that the components of the barrier layer or any coating layers on top of the paperboard substrate shall not migrate to the surface of the coated paperboard and contact the food or liquid contents of the packaging. Such migration problems may aggravate particularly in the case of acidic contents, because such materials tend to react with and dissolve the coating.

In the EU, the safety of so-called Food Contact Materials (FCMs) is evaluated and tested extensively, in accordance with the plastic FCM Regulation (EU) No 10/2011. Food contact materials are either intended to be brought into contact with food, are already in contact with food, or can reasonably be brought into contact with food or transfer their constituents to the food under normal or foreseeable use. FCMs should be sufficiently inert so that their constituents neither adversely affect consumer health nor influence the quality of the food. To ensure the safety of FCMs, and to facilitate the free movement of goods, EU law provides for binding rules that business operators must comply with.

One of the most commonly used fillers in coated paperboards is calcium carbonate. It is inexpensive and, in most application areas, it can be used at high loadings. However, it is easily dissolved when contacted by acidic materials and therefore its use in food and liquid packaging has been very limited.

WO 2017/091391 A1 describes coatings for paperboard which include polyethylene outer layers and a polyethylene middle layer with calcium carbonate filler.

There is a need for providing improved paperboard structures that are capable of incorporating a wider selection of filler materials and which can be safely used in food and liquid packages.

The embodiments of the present invention are intended to overcome at least some of the above discussed disadvantages and restrictions of the previously known coatings.

### SUMMARY OF THE INVENTION

The invention is defined by the features of the independent claims. Some specific embodiments are defined in the dependent claims.

According to a first aspect of the present invention, there is provided a paperboard structure, comprising: a support layer comprising paperboard; a filler layer on top of and in direct contact with the support layer, the filler layer comprising an inorganic filler and a polyolefin; and a plastic coating layer on top of the filler layer and forming the outermost layer of the paperboard structure, the plastic coating layer comprising a polyolefin.

Various embodiments of the first aspect may comprise at least one feature from the following bulleted list:
The inorganic filler is in the form of particles, such as microparticles or nanoparticles.
The inorganic filler is in the form of particles having an average particle size of 0.01 to 3 μm, for example 0.5 to 2 μm.
The inorganic filler is an acid-sensitive inorganic filler, preferably a carbonate-containing filler, for example CaCO₃.
The polyolefin comprises polyethylene.
The plastic coating layer consists of polyethylene.
The thickness of the filler layer is 5 to 100 μm, preferably 5 to 50 μm.
The thickness of the plastic coating layer is 5 to 50 μm, preferably 10 to 30 μm.
The combined dosage produced by the filler layer and the plastic coating layer is 12 to 40 g per m² of the support layer, preferably 12 to 30 g per m² of the support layer.
The amount of inorganic filler in the filler layer is in the range of 5 to 70 wt-%, preferably 10 to 60 wt-%, more preferably 15 to 60 wt-%.
The amount of inorganic filler in the filler layer is at least 20 wt-%.
The paperboard structure is obtained by an extrusion coating method.

According to a second aspect of the present invention, there is provided a package comprising the paperboard structure according to any of the preceding claims.

Various embodiments of the second aspect may comprise at least one feature from the following bulleted list:
The package comprises side seams in which an acidic dispersion adhesive has been used.
The dispersion adhesive has a pH below or equal to 4.5.

According to a third aspect of the present invention, there is provided use of the package for holding acidic contents, such as acidic liquids, acidic flowable materials or acidic food, for example soda, citrus fruit juice, wine, yoghurt or crushed tomatoes.

Various embodiments of the third aspect may comprise at least one feature from the following bulleted list:
The acidic contents have a pH below or equal to 4.5.

By means of the present invention, it is possible to avoid migration of the filler while simultaneously maintaining good sealing and adhesion properties. In this way, the present invention increases versatility in the use of fillers in the manufacturing of food and liquid packages. In the food packaging industry, migration of fillers and any additives is undesired.

Paperboard material having the structure according to the present invention can be used in applications in which incorporation of inorganic fillers and/or pigments into the structure is required.

By adding to the paperboard the coating structure according to the present invention, it is possible to reduce or entirely avoid the migration of filler components or molecules.

The paperboard structure according to the present invention can be used in packages intended for long-term storage of liquid of fluid materials.

At least some embodiments of the present invention improve the strength of side seams in paperboard packages.

The coated paperboard according to some embodiments of the invention can be used for manufacturing a package for such contents that are not chemically compatible with the inorganic filler material of the filler layer in the coating.

### BRIEF DESCRIPTION OF THE DRAWINGS

FIG. 1 illustrates schematically a paperboard structure in accordance with at least some embodiments of the present invention.

### EMBODIMENTS

### Definitions

In the present context, the term “acid-sensitive” refers to materials or compounds that are susceptible of reacting with or being attacked by acidic compounds.

In the present context, the term “polyolefin” refers to an unmodified polyolefin. For example, the term “polyethylene” refers to an unmodified polyethylene.

We have unexpectedly observed that particular inorganic fillers with relatively high loadings can be incorporated in layered paperboard structures without sacrificing good sealing properties.

Particularly, we have found a new paperboard structure comprising acid-sensitive inorganic fillers and/or acid-sensitive pigments. The structure according to the invention provides good sealing properties and simultaneously reduces or avoids migration of filler particles onto the outermost surface of the structure (i.e. the top surface).

In the present paperboard structure, acid-sensitive pigments may be incorporated in the filler layer which is located below the plastic coating layer.

Other acid-sensitive materials or additives that may be added in the filler layer include any carbonate salt.

Some embodiments of the present invention provide the advantage that the acid-sensitive material does not migrate on the outermost surface of the paperboard structure and thus into contact with the ambient environment or with the contents of the package.

In preferred embodiments, an acid-sensitive filler and a polyolefin are used in the filler layer, and by means of applying a plastic coating layer comprising or consisting of a polyolefin on top of the filler layer it is possible to effectively prevent any contact between the filler and acidic contents of the package.

We have observed that the incorporation of acid-sensitive materials in accordance with some embodiments of the present invention does not negatively affect the heat-sealing properties, particularly during cup forming.

At least some embodiments of the present invention improve the strength of side seams in paperboard packages. In such seams, aqueous dispersion adhesives are typically used. These adhesives may be acidic, which makes the seam sensitive to alkaline fillers in the paperboard material.

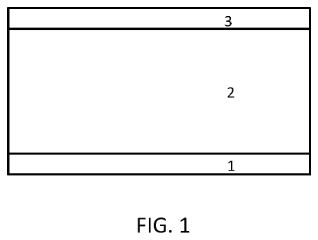

FIG. 1 illustrates a paperboard structure in accordance with at least some embodiments of the present invention.

The structure comprises a support layer 1, a filler layer 2, and a plastic coating layer 3, as a cascade.

The lowermost layer, i.e. the support layer, is made of a paperboard material. The fibre matrix of the paperboard material may comprise bleached or unbleached hardwood pulp, bleached or unbleached softwood pulp, bleached or unbleached mechanical pulp, bleached or unbleached chemi-mechanical pulp or recirculated broke pulp used in paperboard production, or mixtures thereof. In particular, mutual mixtures of the above described bleached and unbleached pulps, respectively, and mechanical or chemi-mechanical pulps, are possible. Recirculated broke pulp may also be used in any of the abovementioned pulps, mechanical pulps and chemi-mechanical pulps.

In some embodiments, paperboard is a single-ply or multi-ply paperboard material. In one embodiment, paperboard has a grammage of at least 150 g/m².

In preferred embodiments, the paperboard structure is folding boxboard.

The middle layer, i.e. the filler layer, comprises an inorganic filler, preferably an alkaline inorganic filler or an acid-sensitive inorganic filler.

Examples of alkaline or acid-sensitive fillers include: calcium carbonate, ground calcium carbonate (GCC), precipitated calcium carbonate (PCC), and other carbonate fillers.

In some embodiments, the inorganic filler is calcium carbonate, ground calcium carbonate, precipitated calcium carbonate or kaolin.

The filler layer may also comprise pigments, such as acid-sensitive pigments. Examples of acid-sensitive pigments include carbonate pigments.

The filler layer is in direct contact with and placed directly on top of the support layer. The filler layer is preferably homogeneous in the sense that the filler is distributed throughout the filler layer, across its entire thickness.

In a preferred embodiment, the filler layer comprises or consists of a mixture of an alkaline inorganic filler and a polyolefin.

In one embodiment, the filler layer comprises or consists of a mixture of a carbonate-containing filler and a polyolefin in the form of microparticles or nanoparticles.

The filler may be in the form of particles, for example particles with an average size in the range of 0.01 to 3 μm, for example 0.5 to 2 μm. Advantageously, the average size of the filler particles is in the range 1 to 2 μm. If the average particle size is larger than 5 μm, the structure of the above-lying plastic coating layer may weaken.

In one embodiment, the thickness of the filler layer is 5 to 100 μm, preferably 5 to 50 μm.

In one embodiment, the amount of inorganic filler in the filler layer is in the range of 5 to 70 wt-%, preferably 10 to 60 wt-%.

In one embodiment, the amount of inorganic filler in the filler layer is at least 20 wt-%.

The plastic coating layer forms the topmost layer of the structure. Advantageously, the plastic coating layer is not in direct contact with the support layer.

In one embodiment, the plastic coating layer comprises or consists of polyolefin, such as polyethylene.

In a preferred embodiment, the plastic coating layer does not contain any inorganic filler.

In one embodiment, the thickness of the plastic coating layer is 5 to 8 μm.

In one embodiment, the combined dosage produced by the filler layer and the plastic coating layer is 12 to 40 g per m² of the support layer, preferably 12 to 30 g per m² of the support layer.

In a preferred embodiment, the paperboard structure consists of the following three layers: the support layer, the filler layer, and the plastic coating layer in this order.

The filler layer and the plastic coating layer are preferably applied by an extrusion coating method, for example co-extrusion coating, on the support layer.

The paperboard structure can be used for manufacturing packages for food industry. The package according to the invention may be for example a paper cup for acidic beverages or a package for yoghurt.

The package is particularly advantageous in holding acidic contents, such as acidic liquids, acidic flowable materials or acidic food. Examples of acidic contents include: acidic beverages, soda, citrus fruit juice, wine, yoghurt, crushed tomatoes. In one embodiment, the pH of the acidic contents is below 4.5.

The paperboard structure according to the invention is advantageous in paperboard packages comprising acidic materials, such as acidic adhesives. In one embodiment, the pH of an adhesive in a seam of the paperboard package is below 4.5.

The entire package or only a part of it may be formed of a paperboard material that comprises the paperboard structure according to the present invention. Preferably, all parts of the package that are in contact with the contents of the package are made of a paperboard material that has the paperboard structure according to the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present invention is industrially applicable for example in the manufacturing of paperboard packages for food industry.

### ACRONYMS LIST

FCM Food Contact Material

### REFERENCE SIGNS LIST

1 support layer
2 filler layer
3 plastic coating layer

### CITATION LIST

### Patent Literature

WO 2017/091391 A1

1. A paperboard structure, comprising:
a support layer comprising paperboard;
a filler layer on top of and in direct contact with the support layer, the filler layer comprising an inorganic filler and a polyolefin; and
a plastic coating layer on top of the filler layer and forming the outermost layer of the paperboard structure, the plastic coating layer comprising a polyolefin.

2. The paperboard structure according to claim 1, wherein the inorganic filler is in the form of particles.

3. The paperboard structure according to claim 1, wherein the inorganic filler is in the form of particles having an average particle size of 0.01 to 3 μm.

4. The paperboard structure according to claim 1, wherein the inorganic filler is an acid-sensitive inorganic filler.

5. The paperboard structure according to claim 1, wherein the polyolefin comprises polyethylene.

6. The paperboard structure according to claim 1, wherein the plastic coating layer consists of polyethylene.

7. The paperboard structure according to claim 1, wherein the thickness of the filler layer is 5 to 100 μm.

8. The paperboard structure according to claim 1, wherein the thickness of the plastic coating layer is 5 to 50 μm.

9. The paperboard structure according to claim 1, wherein the combined dosage produced by the filler layer and the plastic coating layer is 12 to 40 g per m² of the support layer.

10. The paperboard structure according to claim 1, wherein the amount of inorganic filler in the filler layer is in the range of 5 to 70 wt-%.

11. The paperboard structure according to claim 1, wherein the amount of inorganic filler in the filler layer is at least 20 wt-%.

12. The paperboard structure according to claim 1, obtained by an extrusion coating method.

13. A package comprising the paperboard structure according to claim 1.

14. The package according to claim 13, further comprising side seams in which an acidic dispersion adhesive has been used.

15. The package according to claim 14, wherein the dispersion adhesive has a pH below or equal to 4.5.

16. The package according to claim 13, wherein the package stores acidic contents therein, and wherein the acidic contents comprise acidic liquids, acidic flowable materials, or acidic solid foods.

17. The package according to claim 16, wherein the acidic contents have a pH below or equal to 4.5.

18. The paperboard structure according to claim 1, wherein the paperboard is a multi-ply paperboard having a grammage of at least 150 g/m².

19. The paperboard structure according to claim 1, wherein the inorganic filler is in the form of particles having an average particle size of 0.5 to 2 μm.

20. The paperboard structure according to claim 4, wherein the inorganic filler comprises carbonate-containing filler material.
